(19) United States
(12) Patent Application Publication
(10) Pub. No.: US 2025/0364001 A1
(43) Pub. Date: Nov. 27, 2025

(54) SIGNAL ENCODING USING LATENT FEATURE PREDICTION

(71) Applicant: Microsoft Technology Licensing, LLC, Redmond, WA (US)

(72) Inventors: Xiulian PENG, Beijing (CN); Yan LU, Beijing (CN); Huaying XUE, Beijing (CN); Vinod PRAKASH, Redmond, WA (US); Ming-Chieh LEE, Bellevue, WA (US); Mahmood MOVASSAGH, VANCOUVER (CA)

(73) Assignee: Microsoft Technology Licensing, LLC, Redmond, WA (US)

(21) Appl. No.: 18/875,141

(22) PCT Filed: Jun. 14, 2022
(86) PCT No.: PCT/CN2022/098779

§ 371 Date: Dec. 14, 2024

(51) Int. Cl. G10L 19/06; G06N 3/0464; G10L 19/00; G10L 19/038

(52) U.S. Cl. CPC G10L 19/06; G06N 3/0464; G10L 19/038; G10L 2019/0014

(57) ABSTRACT

Techniques and solutions are described for encoding and decoding signals, such as audio data. Disclosed innovations can find particular use in speech coding applications, such as for real time communications. Using a neural network, contextual coding can be used to encode latent features for a current frame using a prediction from reconstructed latent features of past frames as a context. An extractor learns a residual-like feature based on such prediction and latent features of the current frame obtained using an encoder. The residual-like feature is then quantized. At a decoder portion of a coding framework, the quantized feature is dequantized and then combined with a prediction from prior reconstructed latent features to provide reconstructed features of a current frame, which can then be processed by a decoder to provide a reconstructed signal.

### FIELD

The present disclosure generally relates to signal encoding. Particular implementations provide for neural encoding of audio data using latent feature prediction.

### BACKGROUND

Digital technologies have been used to record, store, and transmit audio information since at least the early 1970s. With the advent of the internet, digital audio transmission has exploded in use, including for real-time, streaming uses, such as in voice over IP applications and services, including Microsoft Teams (Microsoft Corp., Redmond, Washington). Although the computing power of personal computing devices continues to improve, as does networking infrastructure, it remains of interest to provide improved audio quality while lowering the amount of data needed to convey audio information. In particular, real-time audio can be more sensitive to transmission and processing delays, as only limited buffering may be available for audio signals. For example, delays in audio processing may prevent participants in a call from effectively communicating with one another. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are described for encoding and decoding signals, such as audio data. Disclosed innovations can find particular use in speech coding applications, such as for real time communications. Using a neural network, contextual coding can be used to encode latent features for a current frame using a prediction from reconstructed latent features of past frames as a context. An extractor learns a residual-like feature based on such prediction and latent features of the current frame obtained using an encoder. The residual-like feature is then quantized. At a decoder portion of a coding framework, the quantized residual-like feature is dequantized and then combined with a prediction from prior reconstructed latent features to provide reconstructed features of a current frame, which can then be processed by a decoder to provide a reconstructed signal.

In one aspect, a method is provided for encoding a signal, such as a digital audio data. One or more latent features are extracted from a frame of an input signal using an encoder. A prediction of the one or more latent features is determined using reconstructed latent features for a plurality of prior frames. A residual-like feature is extracted from the one or more latent features and the prediction. The residual-like feature, or data sufficient to reconstitute the residual-like feature, is sent to a client.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram of a prior art vector-quantized variational autoencoder.

FIG. 2 is a diagram of a vector-quantized variational autoencoder according to an embodiment of the present disclosure.

FIG. 3 present diagrams of filtering techniques that can be used in the vector-quantized variational autoencoder of FIG. 2.

FIG. 4 provides diagrams illustrating variants of the vector-quantized variational encoder of FIG. 2.

FIG. 5 is a graph of audio quality of different audio encoding techniques at different bitrates.

FIG. 6 provides tables illustrating comparative results for various implementations of the vector-quantized variational autoencoder of FIG. 2.

FIG. 7 is a diagram of an overall system according to the present disclosure for using latent feature prediction as a context in a vector-quantized variational autoencoder.

FIGS. 8A and 8B provide details for encoder and decoder portions of the system of FIG. 7.

FIG. 9 is a diagram illustrating a technique for group-wise vector quantization.

FIG. 10 is a flowchart of an example signal encoding technique according to the present disclosure.

FIG. 11 is a diagram of an example computing system in which some described embodiments can be implemented.

FIG. 12 is an example cloud computing environment that can be used in conjunction with the technologies described herein.

### DETAILED DESCRIPTION

### Example 1—Overview

Digital technologies have been used to record, store, and transmit audio information since at least the early 1970s. With the advent of the internet, digital audio transmission has exploded in use, including for real-time, streaming uses, such as in voice over IP applications and services, including Microsoft Teams (Microsoft Corp., Redmond, Washington). Although the computing power of personal computing devices continues to improve, as does networking infrastructure, it remains of interest to provide improved audio quality while lowering the amount of data needed to convey audio information. In particular, real-time audio can be more sensitive to transmission and processing delays, as only limited buffering may be available for audio signals. For example, delays in audio processing may prevent participants in a call from effectively communicating with one another. Accordingly, room for improvement exists.

Artificial intelligence/machine learning techniques, such as neural networks, have been applied to audio data, including for real-time communications. Existing neural audio codecs can be categorized into two types. One type of neural audio codec is based on generative decoder models. At least some generative decoder models extract acoustic features from audio data for encoding after quantization and entropy coding. A strong decoder is used to recover the waveform based on generative models.

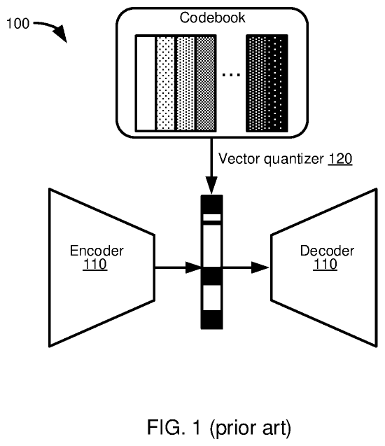

Another type of audio codec that has been investigated is based on end-to-end neural audio coding. End-to-end neural networks typically leverage the VQ-VAE (vector-quantized variational autoencoder) framework, an example 100 of which is illustrated in FIG. 1, to learn an encoder 110, a vector quantizer 120, and a decoder 130 in an end-to-end way, as illustrated in FIG. 1. The latent features to quantize, produced from the encoder, are mostly blindly learned using a convolutional network (CNN) without any prior knowledge of its semantics. These methods can increase the coding efficiency by achieving a high quality at a low bitrate. However, temporal correlations are not fully exploited in these algorithms. There is still much redundancy among neighboring frames in encoded features. In contrast, disclosed innovations incorporate contextual coding into the VQ-VAE-based neural codec framework to remove such redundancies in latent domain, thus further boosting coding efficiency.

Prediction has been used in image, video, and audio coding, such as JPEG, HEVC, H.264/AVC, and DPCM/ADPCM for redundancy removal. In image and intra-frame coding of video, reconstructed neighboring blocks are used to predict the current block, either in pixel or frequency domain, and the predicted residuals are quantized and encoded to a bitstream. In inter-frame coding of video codes, reconstructed reference frames are used to predict the current frame with motion compensation. The residuals after prediction are much sparser and the entropy is largely reduced. In neural video codecs, such temporal correlations can be exploited by utilizing a motion-aligned reference frame as prediction or context for encoding a current frame. In audio coding, DPCM/ADPCM has been used to encode audio samples or acoustic parameters. However, such techniques have not yet been investigated for use in neural audio codecs.

The present disclosure provides for the introduction of contextual coding with temporal predictions into the VQ-VAE framework for neural audio coding. To reduce the delay, this prediction is performed in a latent representation. Unlike traditional video/audio coding, which determine a residual by subtracting samples from predictions, a learnable extractor and synthesizer are used to fuse the prediction with latent features and the quantized output.

Disclosed innovations have particular application to low-latency speech encoding, but can be incorporated into other encoding techniques, and can be used with other types of signals other than audio speech data, and including data other than audio data. The present disclosure provides a number of innovations that can, but are not required, to be used with one another. These innovations include using time-frequency bins as input for a neural encoder, learnable amplitude compression, latent-domain contextual coding for an end-to-end neural audio codec, an improved vector-quantization technique that is rate-controllable, and a scalable encoding framework where the availability of higher transmission bitrates can be used to provide scalable quality using the same encoding framework.

### Example 2—Example Variational Autoencoder With Temporal Filtering

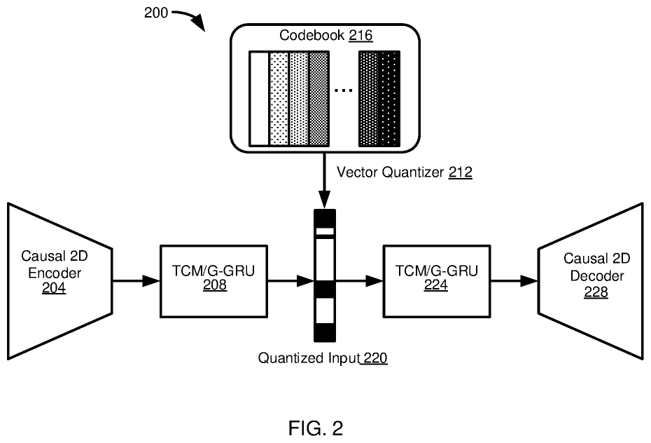

In one aspect, the present disclosure provides a codec that includes a neural network that uses time-frequency input, and which can be referred to as “TFNet.” A particular implementation 200 of TFNet is illustrated in FIG. 2. The implementation includes a causal 2D encoder 204, the output of which is processed using a temporal filter 208 that includes a temporal convolution module (TCM) and a group-wise gated recurrent unit (G-GRU) in an interleaved manner. The output of the filter 208 is quantized by a vector quantizer 212 using a codebook 216 to provide quantized input 220. The quantized input 220 is then provided (such as after being transmitted over a network) to a temporal filter 224 that is configured as for the filter 208, including a temporal convolution module interleaved with a group-wise gated recurrent unit. The output of the filter 224 is provided to a causal 2D decoder 228. The operations of the TFNet implementation 200 will now be further described.

The TFNet-based codec takes a time-frequency spectrum input. The time-frequency spectrum input can be obtained by dividing audio samples into overlapped windows and applying Short-Time Fourier Transform (STFT) on each windowed input to get a frame, where a hop size determines how frequently the input is processed. Although these parameters can be selected as desired, when used for speech processing, a 20 ms window size with a 5 ms hop length can provide good results.

Optionally, the input can be further processed before being provided to the encoder neural network. In particular, power law compression on the amplitude can be applied on the input. The dynamic range of speech can be high due to harmonics. The compression acts to normalize input so that the importance of different frequencies is balanced, and the training is more stable. Optionally, other compression technique can be used to compress the amplitude of the input to the encoder 204.

The encoder 204 exploits local two-dimensional (2D) correlations. The temporal filters 208, 224 exploit longer-term temporal dependencies with past frames for feature extraction. This two-level feature extraction helps in learning to extract features with good representation capability, providing error resilience to packet losses, and possibly removing undesired information, such as background noises, if desired. The learned features are then quantized through a learned vector quantizer and coded in fixed-length coding or Huffman coding. For decoding, there are several temporal filtering blocks followed by a decoder for reconstruction. An inverse power law compression can be applied on the amplitude of decoded spectrum if a power law compression on the amplitude is applied in encoding. Considering the packet losses in real-time communications, the decoding preferably should be resilient to these losses with recovery capability and minimum error propagation. Therefore, a heterogeneous structure is provided, with more temporal filtering blocks for decoding than encoding.

The whole network is end-to-end trained to optimize the reconstruction quality under a rate constraint. The convolutions are causal in the temporal dimension so that the system can keep a low latency, such as a latency of 20 ms in some examples.

### Example 3—TFNet Encoder and Decoder

Referring to FIG. 2, the encoder 204 includes several causal 2D convolutional layers, each followed by a batch normalization (BN) and a parametric ReLU (PRelu) for nonlinearity. After each convolutional layer, the feature is downsampled by 2 or 4 in frequency dimension and finally all frequency information is folded into channels.

Let X^{I}∈R^{T×F×2} denote the input feature. After the processing by the encoder 204, the feature is for X^{E}∈R^{T×1×C} for input into the temporal filter 208. T, F and C are number of frames, frequency bins, and channels, respectively. Convolutions are causal along the temporal dimension, so T is kept without any downsampling. The decoder 228 is symmetric to the encoder 204 with causal 2D deconvolutional layers. The output of the decoder is a reconstructed spectrum X^{R}∈R^{T×F×2}, which is processed using an inverse short-time Fourier transform to provide an output waveform.

### Example 4—Example Temporal Filtering

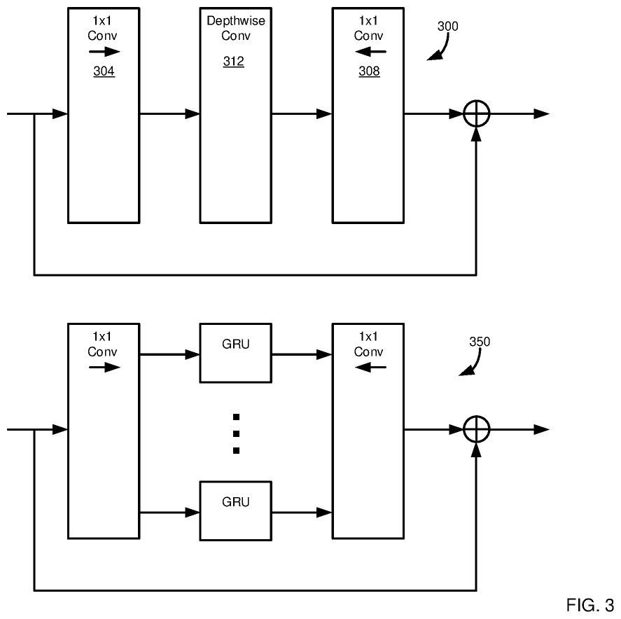

As noted in Example 2, and as shown in FIG. 3, the filters 208, 224 of the TFNet implementation include a dilated temporal convolution module (TCM) 300 and a group-wise gated recurrent unit (G-GRU) 350. Both of these filter elements are causal and low-complexity. The TCM module can be implemented similar to that described in Pandey, et al., “TCNN: Temporal convolutional neural network for real-time speech enhancement in the time domain,” IEEE International Conference on Acoustics, Speech and Signal Processing, :6875-6879 (2019). According to the Pandey reference, it provides:
The residual block consists of 3 convolutions: input 1×1 convolution, depthwise convolution, and output 1×1 convolution. The depthwise convolution is used to reduce the number of parameters further. In a depth-wise convolution, the number of channels is kept the same, and only one filter per input channel is used for the output computation.

The TCM module includes two convolutions 304, 308 with a kernel size of 1×1 to change channel dimensions, and dilated depthwise convolutions 312 to exploit temporal correlations with low complexity. Several TCM blocks with different dilation rates are grouped as a large block to increase the receptive field and diversities.

The group-wise GRU portion of the filters 208, 224 splits channels into N groups and leverages temporal dependencies inside each group independently. The operation of gated recurrent units is described in Cho, et al., “On the Properties of Neural Machine Translation: Encoder-Decoder Approaches,” arXiv:1409.1259 (2014). In particular, the Cho reference describes that gating can be provided using an activation function:
. . . that augments the usual logistic sigmoid activation function with two gating units called reset, r, and update, z, gates. Each gate depends on the previous hidden state h^{(t-1)}, and the current input xₜ controls the flow of information.

Further details of the gated recurrent units are provided in Cho, et al., “Learning Phrase Representations using RNN Encoder-Decoder for Statistical Machine Translation,” arXiv 1406.1078v3 (2014). This Cho reference describes that:
when the reset gate is close to 0, the hidden state is forced to ignore the previous hidden state and reset with the current input only. This effectively allows the hidden state to drop any information that is found to be irrelevant later in the future, thus, allowing a more compact representation.
On the other hand, the update gate controls how much information from the previous hidden state will carry over to the current hidden state. This acts similarly to the memory cell in the LSTM network and helps the RNN to remember long-term information.

This group-wise GRU variant not only reduces complexity, but also increases the flexibility and representation capability for providing frequency-aware temporal filtering as channels are learned from frequencies. TCM can help explore short-term and middle-term temporal evolutions, while GRU can help capture long-term dependencies. Thus, interleaving these two techniques helps capture short-term and long-term temporal correlations at different depths. The experimental results provided in Example 8 verify that the interleaved structures are more efficient than a single structure.

### Example 5—Example Vector Quantization

The vector quantizer discretizes the learned features in encoding with a set of learnable codebooks according to the target bitrate. Before quantization, the features after encoding X^{Q}∈R^{T×1×C} are reduced to X^{Q}∈R^{T×1×C′} through a 1×1 convolution (C′<C). Group quantization is obtained by splitting channels C′ into N groups and coding each group by an independent codebook. Let S denote the number of codewords in each codebook and K=C′/N the dimension of each codeword. In a particular example of the implementation 200, a window length of 20 ms and hop length of 5 ms was adopted for STFT, and thus the bitrate is given by N×log₂ S/5 kps if fixed-length coding is used. For 6 kbps, C′, N, S and K can be set to 120, 3, 1024, and 40, respectively, although other parameter values can be used as appropriate. The codebooks are learned with exponential moving average, following the technique described in van den Oord, et al., “Neural discrete representation learning,” arXiv:1711.00937 (2017). According to that technique, an encoder network outputs discrete codes instead of continuous codes, and uses a prior that is learned rather than being static. Discrete codes can be determined using a nearest neighbor lookup procedure using a shared embedding space. Learning is providing by passing a gradient from decoder input to the encoder, since the encoder and decoder share the same dimensional space. The shared embedding space, i.e. the codebook, is updated as function of moving average of the encoder output zₑ(x).

In particular, an input x can be passed through an encoder to generate an output zₑ(x), where discrete latent variables z can be determined using a shared embedding space e (having embedding vectors eⱼ) for a nearest neighbor look-up. The encoder output can then be passed through a discretization bottleneck, and then mapped onto a nearest embedding e. The following equations can be used, where q(z=k|x) is the posterior categorical distribution probability, and z_{q}(x) is the nearest embedding:

$$q ( z = k \vert x ) = \{ \begin{matrix}1 & for k = {argmin}_{j} {‖ {z}_{e} ( x ) - {e}_{j} ‖}_{2} \\ 0 & otherwise\end{matrix}$$

$${z}_{q} ( x ) = {e}_{k}$$

The quantized features \hat{X}^{Q}∈R^{T×1×C′} can be enlarged to the shape T×1×C before provision to the temporal filter 224 in the decoding portion of the implementation 200.

### Example 6—Example Loss Function

An example loss function useable in the system 200 is a combination of two terms, [symbol] = [symbol] _{recon}+α [symbol] _{VQ}. [symbol] _{recon} is the reconstruction loss, while [symbol] _{VQ} puts a constraint on vector quantization. A mean-square error can be used on the power-law compressed spectrum between the original and the decoded signals for reconstruction loss. To help provide STFT consistency, the decoded spectrum can first be transformed into the waveform domain through an inverse STFT and then transformed into time-frequency domain again through a STFT to calculate the loss. The second term [symbol] _{VQ} is the commitment loss used in VQ-VAE, which forces the encoder 204 to generate a representation close to its codeword, while α is a weighting factor to balance the two terms.

### Example 7—Example TFNet Implementations

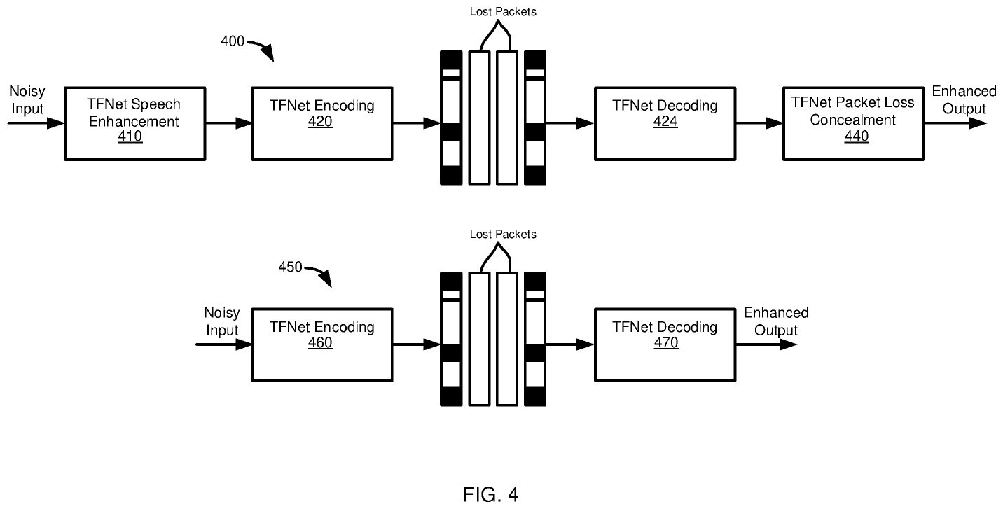

In real-time communications, there are several types of degradations besides quality loss by audio coding, such as background noises and packet losses. Owing to the disclosed end-to-end learnable codec, when used for audio applications, it is feasible to jointly optimize the audio coding with speech enhancement (SE) and packet loss concealment (PLC). Two ways of joint optimization are provided—(1) a cascaded network with an enhancer before the codec and a PLC network after it (FIG. 4, network 400), and (2) an all-in-one network that takes a similar network structure as the codec, but is optimized for noisy input with packet losses (FIG. 4, network 450).

The cascaded network 400 of FIG. 4 includes three modules, an enhancer 410 for pre-processing, an audio codec (encoder 420 and decoder 424), and a PLC network 440 for post-processing. As speech is more efficient in compression than a noisy audio, the enhancer 410 is put before the codec 420. The enhancer 410, encoder 420 and decoder 424, and PLC network 440 can all be based on TFNet-like structures (such as in FIG. 2), and are jointly trained in an end-to-end way. That is, for example, the encoder 420 can include the functionality of the encoder 208 and the filter 208, and the decoder 424 can include the functionality of the filter 224 and the decoder 228.

The pre-processing enhancer 410 takes noisy audio as input and outputs enhanced audio for feeding into the codec. Different from the TFNet-based codec implementation 200, there are skip connections between the encoder and the decoder in the enhancer 410 to get rid of information loss. Causal gated blocks can be used in the decoder, to output an amplitude gain and the phase for reconstruction, which can be implemented in a similar manner as described in Zheng, et al., “Interactive speech and noise modeling for speech enhancement,” AAAI 2021. In Zheng, the gated block “learns a multiplicative mask on corresponding feature from the encoder, aiming to suppress its undesired part.”

Under packet losses, the neural codec is adjusted in that in decoding it takes both the quantized features with lost packets as zero and a mask showing where the loss happens as input. The mask is also injected into each temporal filtering blocks in decoding. The post-processing PLC module 440 operates in the waveform domain, taking a TFNet-based structure with both the decoded audio and the mask as input. There are also skip connections in the PLC network 440 as in the enhancer 410. As a restoration task, the PLC network 440 outputs a complex residue in the time-frequency domain, which is added into the spectrum of the decoded audio for reconstruction.

For training, the three networks can be concatenated and jointly trained from end to end. For better quality, two-stage training can be used. First, the enhancer 410 and the codec 420 can be separately trained with noisy and clean data, respectively. Then the cascaded network 440 cane fine tuned from that, with two additional supervisions at the output of the enhancer and the codec, respectively, using the same reconstruction loss as [symbol] _{recon}.

The all-in-one network 450 is resilient to both background noises and packet losses with only a single codec network that has the same general structure as the TFNet implementation 200, including an encoder 460 (the includes functionality of both the encoder 204 and the filter 208) and a decoder 470 (that includes the functionality of both the filter 224 and the decoder 228). To accommodate packet losses, the decoding part in the codec is adjusted similarly to that in the cascaded network 400. It is trained from scratch with an auxiliary supervision added for the encoding part to remove noises for efficient coding. This is achieved by adding a decoder after the temporal filtering blocks of the encoder, which is forced to output clean audio in training. During inference, this decoder is not needed.

### Example 8—Example Comparative Results

890 hours of 16 khz noisy audios with clean speech, noises and room impulses were synthesized from the Deep Noise Suppression Challenge at ICASSP 2021. The clean audio included multilingual speech, emotional, and singing clips. The signal-to-noise ratio was randomly chosen to be between −5 dB and 20 dB, and the speech level within −40 to −10 dB. Each audio was cut into 3-second segments for training. The speech enhancement performed both denoising and dereverberation. The packet losses were simulated following the three-state model, described in Milner, et al., “An analysis of packet loss models for distributed speech recognition,” Proceedings INTERSPEECH, 8th International Conference on Spoken Language Processing (2004). In the three-state model, one state corresponds to a “good” state where no packet loss occurs, another state corresponds to a “bad” state with a probability of packet less, and the final state can represent a transition from a “good” state to a new state that also is not associated with packet loss. For testing, 1400 audios were used, each 10 seconds long and without any overlap with training data.

During training, the Adam optimizer (see Kingma, et. al., “Adam: A Method for Stochastic Optimization,” arXiv:1412:6980 (2014)) was used with a learning rate of 0.0004. The network was trained for 100 epochs with a batch size of 200. The “Adam” algorithm is a “first-order gradient-based optimization of stochastic objective functions, based on adaptive estimates of lower-order moments.”

In evaluation, except for a subjective listening test, three metrics were used for ablation studies to evaluate joint optimization and for evaluating temporal filter types—PESQ (perceptual evaluation of speech quality), STOI (short-time objective intelligibility), and DNSMOS (deep noise suppression mean opinion score). Although these metrics were not designed and optimized for exactly the same task, it was found that for the same kind of distortions in all compared schemes, they matched well with perceptual quality.

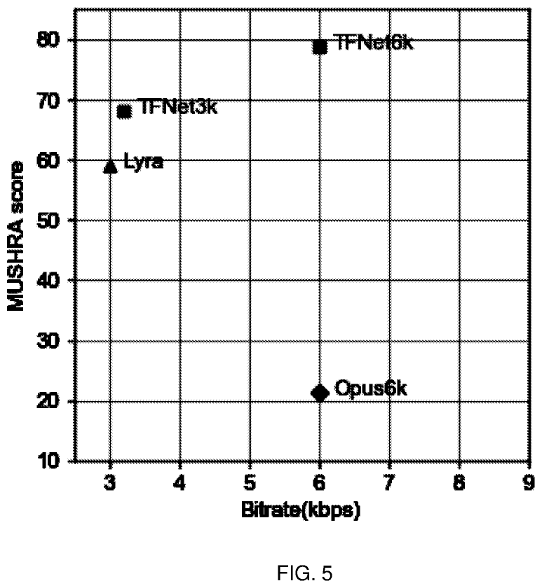

The codec network was trained and measured on the clean data from the Deep Noise Suppression Challenge. A subjective listening test was conducted with a MUSHRA (Multiple Stimuli with Hidden Reference and Anchor)-inspired crowd-sourced method. There were 10 participants. Each participant evaluated 12 samples. The TFNet-based neural codec was compared with Lyra (a neural speech codec, Google LLC) and Opus (Xiph.org Foundation), two codecs used for real-time communications. As shown in FIG. 5, the disclosed TFNet technique at around 3 kbps clearly outperforms Lyra at 3 kbps, and TFNet at 6 kbps is much better than Opus at 6 kbps, which demonstrates the superiority of the disclosed TFNet technique.

Joint optimization of codec, speech enhancement, and PLC (packet loss concealment) was evaluated using noisy/clean paired data with simulated packet loss traces. Three methods were compared: a baseline with separately trained enhancement, coding, and PLC models; the cascaded network; and the all-in-one network. In baseline, coding and PLC networks were trained only using raw, clean data. The enhancer and PLC networks had 470K parameters and 1.2 M MACs per 20 ms, far less than the codec network with 5 M parameters.

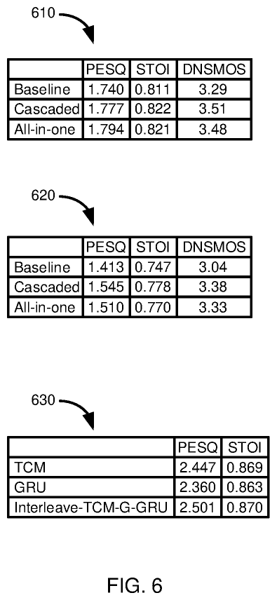

In tables 610, 620 of FIG. 6, the comparative results on two and three task joint optimizations are presented, respectively. It is observed that the two joint optimization methods clearly outperform the baseline in all metrics. Although no pre-processing or post-processing networks are used, the all-in-one network performs competitively with the cascaded one, showing the strong discrimination and representation capability of TFNet. Another observation is that the PLC network trained on raw clean data in baseline method is sensitive to mismatch in the input.

The interleaved structure in TFNet neural codec was compared with separate use of two modules, TCM and GRU, commonly used in regression tasks of speech enhancement. All schemes were compared under the same computational complexity with 1.4 M parameters and 3.3 M MACs for each 20 ms window for encoding and decoding. All temporal filtering modules were used for decoding only to evaluate their recovery capability.

Table 630 of FIG. 6 shows the comparison results. It can be seen that the interleaved structure performs the best for capturing both short-term and long-term temporal correlations.

### Example 9—Overview of Vector-Quantized Variational Autoencoder With Latent Feature Prediction

Examples 9-13 describe a low-bitrate and scalable contextual neural audio codec for real-time communications based on the VQ-VAE framework. The codec incorporates features of the codec described in Examples 1-8. The codec of Examples 9-13 learns encoding, a vector quantization codebook, and decoding in an end-to-end way. Different from existing neural audio codecs that employ either acoustic features or learned blind features with a convolutional neural network for encoding, by which there are still temporal redundancies inside features being quantized, contextual coding with latent feature prediction is introduced into the VQ-VAE framework to further remove such redundancies. Channel-wise group vector quantization with random dropout is used to help provide bitrate scalability in a single model and a single bitstream. Subjective evaluations show that the disclosed technical can achieve acceptable speech quality at 1 kbps, and near-transparent quality at 6 kbps.

The disclosed techniques provide a number of features and advantages, which can be used in real-time communication applications as well as other applications, including for compressing other types of audio information. One feature is that time-frequency bins are used as network input for end-to-end neural audio coding. Another feature is the use of learnable amplitude compression for low-bitrate coding. Latent-domain contextual coding is used for end-to-end neural audio coding. The disclosed techniques also provide a vector quantization feature that supports rate control. A further feature is channel-wise bitrate scalability, where audio quality can be scaled to higher levels as bitrate increases.

### Example 10—Example Vector-Quantized Variational Autoencoder With Latent Feature Prediction

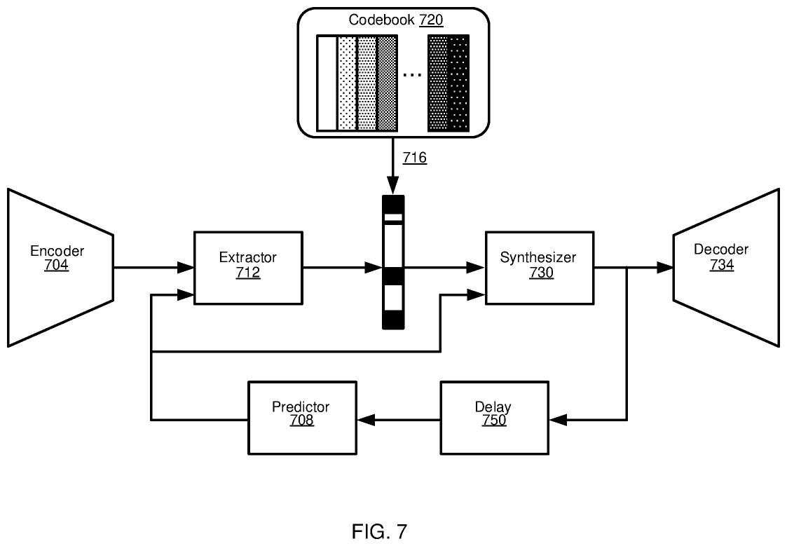

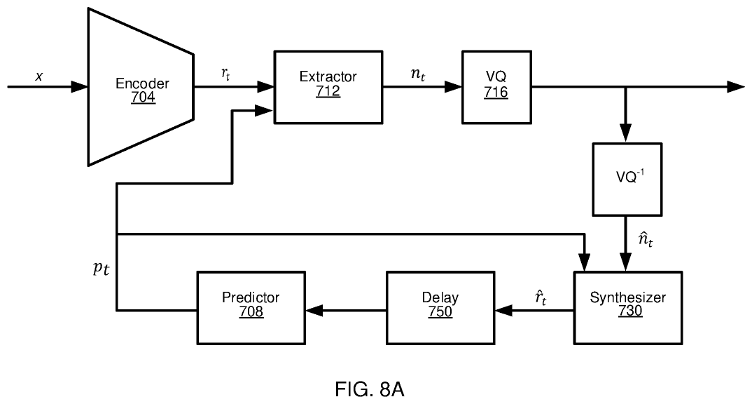

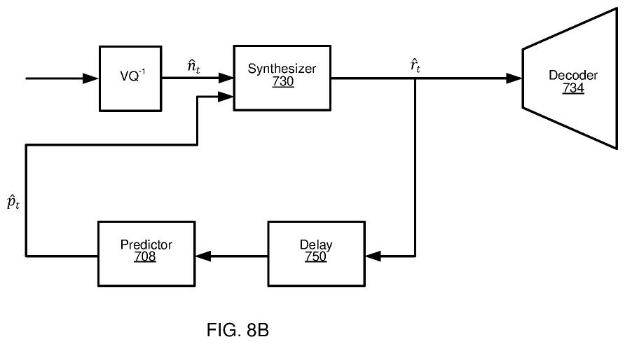

FIG. 7 illustrates an example neural codec 700 according to the present disclosure, and in particular Examples 9-13, that performs contextual coding in a latent representation, to reduce delay. The codec 700 is split into an encoding portion 800 and a decoding portion 850, as illustrated in FIGS. 8A and 8B. The technique is described with particular application to low-latency speech coding, but can be used for other applications, including as a codec for other types of audios. The basic encoder and decoder networks 800, 850 are similar to that described with respect to Examples 1-8.

An encoder 704 is applied to extract latent representations r from input audio x (FIG. 8A). For each frame rₜin r, the encoder 704 leverages a prediction learned from past reconstructed latent codes pₜ=ƒ(\hat{r}ₜ₋ᵢ|i=1,2, . . . , N) through a predictor 708 with a receptive field of N past frames. Then an extractor 712 learns residual-like information from both rₜ and pₜ for quantization. With this auto-regressive operation, the temporal redundancy can be effectively reduced without introducing any error propagation among frames. The extracted residual-like feature is then quantized by a vector quantizer 716 (FIG. 8A) using a learned codebook 720 (FIG. 7), and entropy coded using Huffman coding (although other types of coding can be used). In particular, the output of the vector quantizer 716 can include quantization indices into the learned codebook 720, which are then entropy coded, such as into a bitstream. In turn, the bitstream can be sent to a client to be decoded. The quantization indices, including as encoded into a bitstream, can be referred to as “data sufficient to reconstitute the residual-like feature.”

At the decoding portion 850 (FIG. 8B), the dequantized residual-like feature is merged with a prediction pₜ from past reconstructed latent features through a synthesizer 730 to get the current reconstructed latent code \hat{r}ₜ. Then a decoder 734 is employed to reconstruct the waveform \hat{x}. In the following Examples, these modules will be described in detail.

### Example 11—Example Amplitude Compression of Input Data

Typical neural networks either take time-domain samples in end-to-end neural coding or mel-scale features in generative neural coding. The disclosed technology uses short-time Fourier transform (STFT) domain for feature extraction. The time-frequency spectrum X_{t,ƒ} by a STFT is used as the encoder input. Due to harmonics of speech, there is a large dynamic range in X_{t,ƒ} which can make the training unstable. To balance between importance of different frequencies and bitrates, a learnable power compression is further introduced on the amplitude of X_{t,ƒ} by

$${A}_{t , f}^{γ} ,$$

where A_{t,ƒ} is the amplitude of X_{t,ƒ} and γ is the power parameter to learn during training. By this learnable amplitude compression, at low bitrates more attention is paid to main components, while at high bitrates more details will receive attention as well.

### Example 12—Example Latent-Domain Contextual Coding

As the contextual coding is auto-regressive, to reduce the delay (at 750) it is investigated in latent domain. As shown in FIG. 7, and the encoding/decoding split is shown in FIGS. 8A and 8B, there is a predictor 708 to predict each frame in latent features rₜ from past reconstructed latent features \hat{r}ₜ₋ᵢ, i=1,2, . . . , N. As the prediction pₜ may contain some undesired information for encoding frame t, in particular implementations, instead of residual coding by rₜ-pₜ, an extractor is employed on rₜ and pₜ to extract new information nₜ for frame t that could not be estimated from the past. nₜis then quantized using vector quantization. Accordingly, as used herein, an “extractor”/“extraction”/“extracting” refer to obtaining “new” information from the latent features and the prediction, not simply calculating a difference between them (such as via subtraction). The term “residual-like feature” is intended to distinguish this “new” information from residuals calculated as differences between latent feature and a prediction. However, in other aspects, a residual (as opposed to a residual-like feature) calculated by such a difference, or just the encoder output without contextual coding, can be used with various disclosed innovations. Symmetrically, for reconstructing latent codes of current frame, a synthesizer 730 is employed to merge pₜ and dequantized output \hat{n}ₜ to get \hat{r}ₜ.

The predictor 708 provides non-linear prediction of current frame from the past, given by pₜ=ƒ(\hat{r}ₜ₋ᵢ|i=1,2, . . . , N) with a window of N frames. Two convolutional layers can be used, such with a kernel size of 5 and 3, followed by parametric ReLU (PRELU), wherein ReLU is the rectified linear unit activation function) to get a receptive field of N=7 frames.

To guide the predictor 708 with good prediction accuracy, a prediction loss is introduced in the training as Lₚ=E(D(pₜ, sg(rₜ))), where D(19 ) is a distance metric given by L1. sg(·) is the stop-gradient operator, used for more stable training.

Both the extractor 712 and the synthesizer 730 include one convolutional layer with a kernel size of 1, followed by parametric ReLU as the nonlinear activation function.

As quantization is not differentiable, a technique is used to learn the codebook and perform back propagation through the vector quantization process. Suitable methods include VQ-VAE with commitment loss, exponential moving average (EMA), Gumbel-Softmax (see Jang, et al., “Categorical Reparameterization with Gumbel-Softmax,” ICLR 2017), and soft-to-hard (see Agustsson, et al. “Soft-to-Hard Vector Quantization for End-to-End Learning Compressible Representations,” arXiv 1704.00648v2 (2017). According to Jang, Gumbel-Softmax involves “a continuous distribution on the simplex that can approximate categorical samples, and whose parameter gradients can be easily computing using the reparameterization trick.” In addition, “The Gumbel-Softmax distribution interpolates between discrete one-hot-encoded categorical distributions and continuous categorical densities.” According to Agustsson, “soft-to-hard” uses
soft assignments of a given scalar or vector to be quantized to quantization levels. A parameter controls the “hardness” of the assignments and allows to gradually transition from soft to hard assignments during training. In contrast to rounding-based or stochastic quantization schemes, our coding scheme is directly differentiable, thus trainable end-to-end.
   Among these methods, Gumbel-Softmax and soft-to-hard allow for the probability of selecting a codeword, and thus make rate control feasible.

However, Gumbel-Softmax uses a linear projection to select the codeword without explicitly correlating it with the quantization error. The soft-to-hard technique gives soft assignments based on distances with different codewords, but a weighted average of codewords instead of a single codeword is used for quantization in training, which leads to a gap between training and inference.

In light of this, in a particular implementation, a modified mechanism combines distance-to-soft mapping with Gumbel-Softmax, to provide a non-linear projection as opposed to the linear-projection of Gumbel-Softmax. Let K denote the number of codewords of a codebook C. The probability for selecting the k-th codeword cₖ to quantize nₜ is given by:

$${d}_{t , k} = D ( {n}_{t} , {c}_{k} )$$

$${q}_{t , k} = \frac{{e}^{( - ∝ \cdot {d}_{t , i} + {v}_{t , i} ) / {τ}^{′}}}{{\sum }_{k = 1}^{K} {e}^{( - α \cdot {d}_{t , i} + {v}_{t , i} ) / {τ}^{′}}}$$

where τ is the temperature of Gumbel Softmax and vₖ∈Gumbel(0,1) are samples drawn from Gumbel distribution. D(·) is a distance metric, and L2 is used in a particular implementation. α is a scalar to control mapping from distance D(nₜ, cₖ) to logits. During forward pass, hard assignment can be used, while during backward pass, the gradient with respect to logits is used.

With q_{t,k}, the rate control is conducted over each minibatch by:

$${L}_{r} = \vert {R}_{target} - ℋ ( q ) \vert$$

$$ℋ ( q ) = {\sum }_{k = 1}^{K} - {E}_{b , t} ( {q}_{b , t , k )} log ( {E}_{b , t} ( {q}_{b , t , k} ) )$$

$${E}_{b , t} ( {q}_{b , t , k} ) = ( {\sum }_{b = 1}^{B} {\sum }_{L = 1}^{T} {q}_{b , t , k} ) / BT$$

where E_{b,t}(·) is the expectation value over all T frames of all B audios in each training minibatch. R_{target} is the average number of target bits per each frame. This loss Lᵣ not only constraints the average rate, but also performs rate-distortion optimization by L_{RD}=D(x, \hat{x})+λLᵣ. When the current entropy is higher than R_{target}, it will push similar features quantized to the same codeword through a tradeoff between rate and distortion; whereas when it is lower than R_{target}, similar features may be quantized to different codewords to retain a higher quality but higher rate.

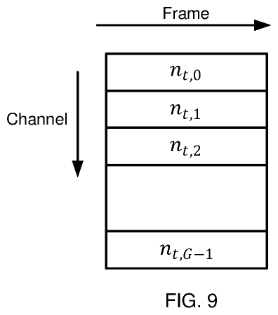

To reduce the codebook size for easy training, group vector quantization is employed. Specifically, each frame nₜ is split into G groups along the channel dimension (FIG. 9) and each group n_{t,c} is quantized with a separate codebook with K codewords. In particular implementations, a large codebook size can be used to help capture the real distribution of the latent features through the rate-distortion optimization. For example, if it is desired to achieve 6 kbps for 16 khz audio, each 20 ms new data is expected to consume 120 bits. Then the codebook is set by G·log₂(K)>120.

### Example 13—Example Techniques for Bitrate Scalability

Bitrate scalability is a desirable feature for streaming and real-time communications to support different receivers with different network conditions without any transcoding. Bitrate scalability can support multiple bitrates in a single bitstream. Specifically, a bitstream can be split into S layers {Bᵢ|i=0,1, . . . , S−1}, where B₀ is the base layer and B₁, B₂, . . . , B_{S-1} are enhancement layers. Receivers with only B₀ will get the lowest quality, while receivers with B₀, B₁, B₂, . . . , Bᵢ₋₁, i<S will get higher quality. The best quality is achieved when i=S.

Existing scalable neural audio codecs generally leverage the residual vector quantization to achieve bitrate scalability, where all channels are trained with a single codebook for lowest bitrate and for higher bitrates more codebooks are used to encode the residual between the encoder feature and its previous reconstruction. Instead, channel-wise bitrate scalability can be used by leveraging the channel-wise group VQ as described above with dropout during training. As shown in FIG. 9, i-th group feature n_{t,i} uses a separate codebook for quantization. n_{t,0} can be take as the base layer, and n_{t,1}, n_{t,2}, . . . , n_{t,G-1} as the enhancement layers so it can support G bitrates. During training, for each minibatch a bitrate bₛ is randomly chosen, which uses only {n_{t,i}|i=0,1, . . . , s, s<S}, and sets features to achieve bitrates above bₛ as zero, i.e. {n_{t,i}|i=s+1, s+2, . . . , S−1} are set to zero. In this way, the decoder is guided to learn restoration from multiple bitrates thus it can achieve scalability in a single model.

### Example 14—Example Encoder With Latent Feature Prediction

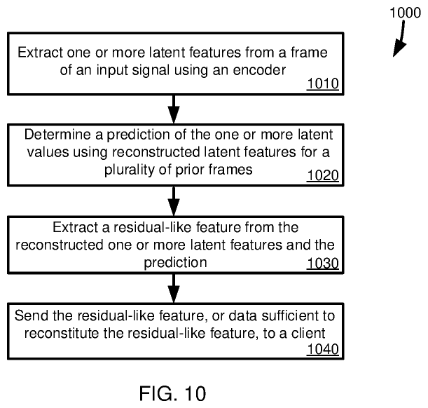

FIG. 10 is a flowchart of an example signal encoding method 1000 according to the present disclosure. At 1010, one or more latent features are extracted from a frame of an input signal using an encoder. A prediction of the one or more latent features is determined at 1020 using reconstructed latent features for a plurality of prior frames. At 1030, a residual-like feature is extracted from the extracted one or more latent features and the prediction. The residual-like feature, or data sufficient to reconstitute the residual-like feature, is sent to a client at 1040 for decoding.

### Example 15—Additional Examples

Example 1 is a computing system that includes at least one memory and at least one hardware processor coupled to the at least one memory. The computing system further includes one or more computer-readable storage media storing computer executable instructions that, when executed, cause the computing system to perform various operations. The operations include extracting one or more latent features from a frame of an input signal using an encoder to provide extracted one or more latent features. A prediction of the one or more latent features is determined using reconstructed latent features for a plurality of prior frames. A residual-like feature is extracted from the extracted one or more latent features and the prediction. The residual-like feature, or data sufficient to reconstitute the residual-like feature, is sent to a client.

Example 2 includes the subject matter of Example 1, and further specifies that the input signal includes audio data, such as speech data.

Examples 3 includes the subject matter of Example 1 or Example 2, and further specifies that the extracting include the use of at least one convolution layer.

Example 4 includes the subject matter of any of Examples 1-3, and further specifies that the input signal includes time-frequency spectrum data.

Example 5 includes the subject matter of Example 4, and further specifies that the time-frequency spectrum data is obtained using a short-time Fourier transform of a time window of the input signal.

Example 6 includes the subject matter of Example 4 or Example 5, and further specifies that amplitude compression is applied to the time-frequency spectrum data.

Example 7 includes the subject matter of Example 6, and further specifies that the amplitude compression is applied using a value determined during training of the encoder.

Example 8 includes the subject matter of Example 7, and further specifies that the value differs for different encoding bitrates.

Example 9 includes the subject matter of any of Example 1-8, and further specifies that the encoder includes a plurality of convolution layers.

Example 10 includes the subject matter of any of Examples 1-9, and further specifies that the determining a prediction includes processing the reconstructed latent features for the plurality of prior fames using a plurality of convolution layers.

Example 11 includes the subject matter of any of Examples 1-10, and further species that the quantizing the residual-like feature includes splitting the residual-like feature into a plurality of groups along a channel dimension, and separately quantizing groups of the plurality of groups.

Example 12 includes the subject matter of Example 11, and further specifies that a given group of the plurality of groups includes a plurality of frequencies.

Example 13 includes the subject matter of Example 12, and further specifies that the channels are quantized using different codebooks. For a set of input training data used during training of the encoder, a group of the plurality of groups is randomly selected, where groups are associated with sets of progressively higher bitrates. During training of the encoder using the set of input training data, only the selected group of the plurality of groups and groups of the plurality of groups associated with lower bitrates than the selected group are used.

Example 14 includes the subject matter of any of Examples 1-13, and further specifies that quantizing the residual-like feature includes for the frame, determining a distance between the residual-like and a codeword of a codebook used for vector quantization of the residual-like feature and determining a probability of selecting the codeword at least in part using the distance.

Examples 15 includes the subject matter of Example 14, and further specifies that the probability is determined as a non-linear projection.

Example 16 includes the subject matter of Example 14 or Example 15, and further specifies that determining a probability includes selecting elements of a Gumbel distribution.

Example 17 includes the subject matter of any of Examples 1-16, and further specifies that the residual-like feature, or the data sufficient to reconstitute the residual-like feature, is sent as part of a bitstream having a rate. During training of the encoder, a bitrate is determined for training input data, where determining a bitrate includes determining a difference between a target bitrate and an entropy of probabilities of selecting particular codewords of a codebook for frames of the training input data.

Example 18 includes the subject matter of Example 17, and further specifies optimizing a rate distortion factor determined as a tradeoff of a determined distortion and the bitrate for the training input data.

Example 19 is one or more computer-readable media storing computer-executable instructions that, when executed, cause the computing system to perform various operations. The operations include extracting one or more latent features from a frame of an input signal using an encoder to provide extracted one or more latent features. A prediction of the one or more latent features is determined using reconstructed latent features for a plurality of prior frames. A residual-like feature is extracted from the extracted one or more latent features and the prediction. The residual-like feature, or data sufficient to reconstitute the residual-like feature, is sent to a client. Additional Examples include the subject matter of Example 19 and that of any of Examples 2-18 and 27-31, in the form of computer-executable instructions.

Example 20 is a method that can be implemented in hardware, software, or a combination thereof. One or more latent features are extracted from a frame of an input signal using an encoder to provide extracted one or more latent features. A prediction of the one or more latent features is determined using reconstructed latent features for a plurality of prior frames. A residual-like feature is extracted from the extracted one or more latent features and the prediction. The residual-like feature, or information sufficient to reconstitute the residual-like feature, is sent to a client. Additional Examples include the subject matter of Example 20 and that of any of Examples 2-18 and 27-31, in the form of additional elements of the method.

Example 21 is a computing system that includes at least one memory and at least one hardware processor coupled to the at least one memory. The computing system further includes one or more computer-readable storage media storing computer executable instructions that, when executed, cause the computing system to perform various operations. The operations include receiving a residual-like feature, or data sufficient to reconstitute a residual-like feature. A prediction is determined of the one or more latent values using reconstructed latent features for a plurality of prior frames. The prediction and the residual-like feature are combined to provide one or more reconstructed latent features for a frame of an input signal. The one or more reconstructed latent features are provided to a decoder to provide a decoded output signal.

Example 22 includes the subject matter of Example 21, and further specifies that the output signal includes audio data, such as speech data.

Example 23 includes the subject matter of Example 21 or Example 22, and further specifies that the decoder includes a plurality of convolution layers.

Example 24 includes the subject matter of any of Examples 21-23, and further specifies that the determining a prediction includes processing the reconstructed latent features for a plurality of prior fames using a plurality of convolution layers.

Example 25 includes the subject matter of any of Examples 21-24, and further specifies that data sufficient to reconstitute the residual-like feature includes quantization indices into a codebook use for dequantization.

Example 26 includes the subject matter of Example 25, and further specifies that the quantization indices are received in a bitstream.

Example 27 includes the subject matter of any of Examples 1-18, and further includes quantizing the residual-like feature.

Example 28 include the subject matter of Example 27, where the quantizing the residual-like feature provides quantization indices into a codebook used in the quantizing.

Example 29 includes the subject matter of Example 28, and further includes coding the quantization indices into a bitstream.

Example 30 includes the subject matter of Example 29, and further specifies that the coding is entropy coding.

Example 31 includes the subject matter of Example 30, and further specifies that the entropy coding is Huffman coding.

### Example 16—Computing Systems

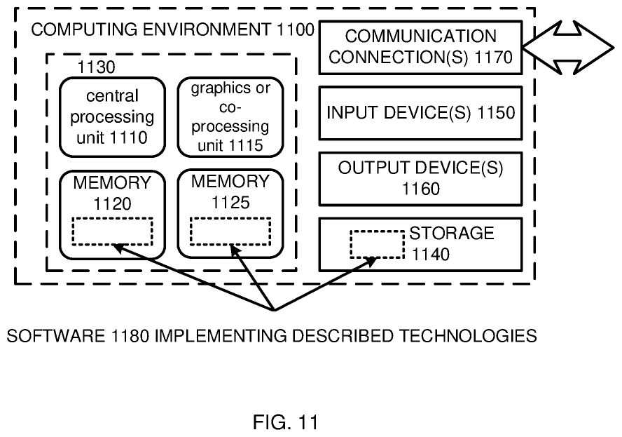

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing the features described in Examples 1-15. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170, including input devices, output devices, and communication connections for interacting with a user. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way, and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 17—Cloud Computing Environment

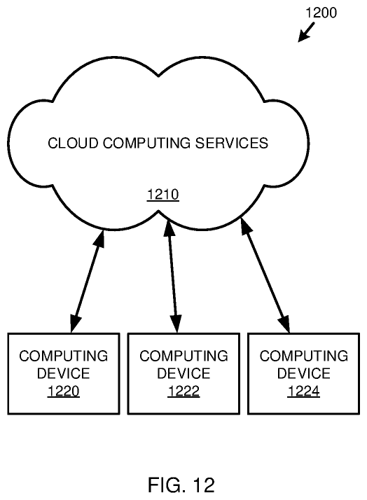

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

### Example 18—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computing system comprising:
at least one hardware processor;
at least one memory coupled to the at least one hardware processor; and
one or more computer-readable storage media comprising computer-executable instructions that, when executed, cause the computing system to perform operations comprising:
extracting one or more latent features from a frame of an input signal using an encoder to provide extracted one or more latent features;
determining a prediction of the one or more latent features using reconstructed latent features for a plurality of prior frames;
extracting a residual-like feature from the extracted one or more latent features and the prediction; and
sending the residual-like feature, or data sufficient to reconstitute the residual-like feature, to a client.

2. The computing system of claim 1, wherein the input signal comprises audio data.

3. The computing system of claim 1, wherein the extracting comprises the use of at least one convolution layer.

4. The computing system of claim 1, wherein input signal comprises time-frequency spectrum data.

5. The computing system of claim 4, wherein the time-frequency spectrum data is obtained using a short-time Fourier transform of a time window of the input signal.

6. The computing system of claim 4, the operations further comprising applying amplitude compression to the time-frequency spectrum data.

7. The computing system of claim 6, wherein the amplitude compression is applied using a value determined during training of the encoder.

8. The computing system of claim 7, wherein the value differs for different encoding bitrates.

9. The computing system of claim 1, wherein the encoder comprises a plurality of convolution layers.

10. The computing system of claim 1, wherein the determining a prediction comprises processing the reconstructed latent features for the plurality of prior frames using a plurality of convolution layers.

11. The computing system of claim 1, the operations further comprising:
splitting the residual-like feature into a plurality of groups along a channel dimension and separately quantizing groups of the plurality of groups.

12. The computing system of claim 11, wherein a given group of the plurality of groups comprises a plurality of frequencies.

13. The computing system of claim 12, wherein the channels are quantized using different codebooks, the operations further comprising, during training of the encoder:
for a set of input training data used during training of the encoder, randomly selecting a group of the plurality of groups, wherein groups are associated with sets of progressively higher bitrates; and
during training of the encoder using the set of input training data, using only the selected group of the plurality of groups and groups of the plurality of groups associated with lower bitrates than the selected group.

14. The computing system of claim 1, the operations further comprising:
quantizing the residual-like feature, the quantizing comprising:
for the frame, determining a distance between the residual-like feature and a codeword of a codebook used for vector quantization of the residual-like feature; and
determining a probability of selecting the codeword at least in part using the distance.

15. The computing system of claim 14, wherein the determining a probability is determined as a non-linear projection.

16. The computing system of claim 14, wherein the determining a probability comprises selecting elements of a Gumbel distribution.

17. The computing system of claim 1, wherein the residual-like feature, or the data sufficient to reconstitute the residual-like feature, is sent as part of a bitstream having a rate, the operations further comprising:
during training of the encoder, determining a bitrate for training input data, the determining a bitrate comprising determining a difference between a target bitrate and an entropy of probabilities of selecting particular codewords of a codebook for frames of the training input data.

18. The computing system of claim 17, the operations further comprising:
optimizing a rate distortion factor determined as a tradeoff of a determined distortion and the bitrate for the training input data.

19. A method, implemented in a computing system comprising at least one hardware processor and at least one memory coupled to the at least one hardware processor, the method comprising:
extracting one or more latent features from a frame of an input signal using an encoder to provide extracted one or more latent features;
determining a prediction of the one or more latent features using reconstructed latent features for a plurality of prior frames;
extracting a residual-like feature from the extracted one or more latent features and the prediction; and
sending the residual-like feature, or data sufficient to reconstitute the residual-like feature, to a client.

20. One or more computer-readable storage media comprising:
computer-executable instructions that, when executed by a computing system comprising at least one hardware processor and at least one memory coupled to the at least one hardware processor, cause the computing system to extract one or more latent features from a frame of an input signal using an encoder to provide extracted one or more latent features;
computing-executable instructions that, when executed by the computing system, cause the computing system to determine a prediction of the one or more latent features using reconstructed latent features for a plurality of prior frames;
computing-executable instructions that, when executed by the computing system, cause the computing system to extract a residual-like feature from the extracted one or more latent features and the prediction; and
computing-executable instructions that, when executed by the computing system, cause the computing system to send the residual-like feature, or data sufficient to reconstitute the residual-like feature, to a client.
